(19) United States
(12) Patent Application Publication
(10) Pub. No.: US 2026/0294605 A1
(43) Pub. Date: Oct. 1, 2026

(54) CONTROL METHOD OF ELECTRIC TOOTHBRUSH, AND ELECTRIC TOOTHBRUSH

(71) Applicant: CIXI SEAGO ELECTRONICS CO., LTD, Cixi (CN)

(72) Inventors: Yanzhong Cai, Cixi (CN); Huiming Liu, Cixi (CN); Zhuting Dong, Cixi (CN); Zhimin Liu, Cixi (CN)

(21) Appl. No.: 19/319,829

(22) Filed: Sep. 5, 2025

(30) Foreign Application Priority Data
Mar. 28, 2025 (CN) 202510387659.5

(51) Int. Cl. A61C 17/34; A46B 5/00; A46B 13/02; A46B 15/00; A61C 17/22

(52) U.S. Cl. CPC A61C 17/3472; A46B 5/0095; A46B 13/023; A46B 15/0006; A46B 15/0085; A61C 17/221; A61C 17/3481; A61C 2204/005

(57) ABSTRACT

The present disclosure provides a control method of the electric toothbrush and the electric toothbrush, wherein the electric toothbrush includes a sonic mode and a rotating mode, and the electric toothbrush can switch between the sonic mode and the rotating mode.

### CROSS-REFERENCE TO RELATED APPLICATIONS

The present disclosure claims the priority to the Chinese patent application No. 202510387659.5 filed with the Chinese Patent Office on Mar. 28, 2025, and entitled “ELECTRIC TOOTHBRUSH”, the contents of which are incorporated herein by reference in entirety.

### TECHNICAL FIELD

The present disclosure relates to the field of electric toothbrushes, and in particular to a control method of an electric toothbrush and an electric toothbrush.

### BACKGROUND ART

Different electric toothbrushes have different functional principles. The sonic electric toothbrush and rotating electric toothbrush are two major types of electric toothbrushes with different functional principles. The sonic electric toothbrush mainly relies on high-frequency vibration to drive the toothbrush head to swing at high speed, and the rotating electric toothbrush mainly relies on the motor to drive the round brush head to rotate. The movements output by motors of these two types of electric toothbrushes are different.

CN116348062A discloses a personal care system and method, wherein the personal care device includes a motor having a drive shaft. In response to the voltage signal, the drive shaft performs a swinging motion with a certain amplitude. The control circuitry includes an operable collaborative user interface, a processor, a pulse width modulation signal generator, and a power source. The control circuit supplies a voltage signal to the motor, and the voltage signal has a frequency and a duty cycle. The control circuit changes the frequency and the duty cycle of the voltage signal in response to the swing amplitude adjustment input received from the user interface, so that the swing amplitude of the drive shaft changes along a substantially linear variation curve relative to the frequency. The object of CN116348062A is to provide an electric toothbrush that performs a swing motion capable of being smoothly and continuously adjusted from one intensity to another without any step or jump in the swing. However, this electric toothbrush does not integrate the sonic electric toothbrush with the rotating electric toothbrush.

CN208319355U discloses an electric toothbrush with alternating switching of vibration mode. The electric toothbrush with alternating switching of vibration mode includes a brush handle and a toothbrush head. The brush handle has a built-in controller and a motor, the toothbrush head is connected to the motor, and the motor drives the toothbrush head to vibrate rotationally or linearly under the control of the controller at different times. The toothbrush head can vibrate linearly or rotationally driven by the motor, and the toothbrush head can switch from the linear vibration to rotational vibration or from the rotational vibration to linear vibration under the action of the controller.

The motor used in CN208319355U is a driving motor capable of outputting rotary vibration or linear vibration, respectively, and the motor can drive the toothbrush head to vibrate linearly or rotationally respectively at different times under the control of a controller. The motor and the toothbrush head are connected by a mode switching mechanism, where the mode switching mechanism is electrically connected to the controller, and the mode switching mechanism is configured to switch the toothbrush head between a linear vibration mode and a rotational vibration mode under the control of the controller. Generally, the structures of the vibrating toothbrush head and the rotating toothbrush head are different, and CN208319355U does not disclose or reveal the switching of toothbrush heads.

CN210044170U discloses an electric toothbrush, and the electric toothbrush includes: a body, a brush head, a brush rod, and a brush handle, where the brush handle having a first accommodation space therein is connected to the other end of the brush rod. The brush handle includes a support frame and a motor, wherein the motor is fixed on the support frame by the connection member and the motor includes a first oscillator and a second oscillator. The brush handle further includes a control circuit board, wherein the control circuit board is connected to the motor, and the control circuit board includes a first circuit and a second circuit. The first circuit controls the first oscillator, and the second circuit controls the second oscillator. The brush handle further includes a vibration transmission shaft, and the vibration transmission shaft drives the brush head to vibrate. The electric toothbrush, utilizing a dual-core motor, has two sonic modes, where the first sonic mode is an axial reciprocating mode, and the second sonic mode is a shaft-rotating mode.

Similarly to CN208319355U, CN210044170U does not disclose or reveal the switching of the toothbrush heads.

### SUMMARY

The present disclosure is made in view of the state of the prior art described above. An objective of the present disclosure is to provide a control method of an electric toothbrush and an electric toothbrush.

The embodiments of the present disclosure provide a control method of an electric toothbrush, wherein the electric toothbrush includes a sonic mode and a rotating mode, and the electric toothbrush can switch between the sonic mode and the rotating mode.

In at least one possible embodiment, the sonic mode and the rotating mode are switched by a strain-based manner.

In at least one possible embodiment, the sonic mode and the rotating mode are switched by a level switching button and/or an identification point.

In at least one possible embodiment, the electric toothbrush includes a toothbrush handle, a sonic toothbrush head, and a rotating toothbrush head, wherein the toothbrush handle is provided with an identification point, and the sonic toothbrush head and the rotating toothbrush head are provided with identification objects having different identification features.

Under a condition that the sonic toothbrush head or the rotating toothbrush head is mounted to the toothbrush handle,
when the sonic toothbrush head is mounted on the toothbrush handle, the identification point transmits a first signal to a control system in the toothbrush handle, and the control system adjusts an operation mode of the electric toothbrush to a sonic mode after receiving the first signal; and
when the rotating toothbrush head is mounted on the toothbrush handle, the identification point transmits a second signal to a control system in the toothbrush handle and the control system adjusts an operation mode of the electric toothbrush to a rotating mode after receiving the second signal.

In at least one possible embodiment, bristles of the sonic toothbrush head move reciprocally in a length direction of the electric toothbrush when the operation mode of the electric toothbrush is the sonic mode, and
bristles of the rotating toothbrush head rotate reciprocally around an axis extending in a frontward/rearward direction of the electric toothbrush when the operation mode of the electric toothbrush is the rotating mode.

In at least one possible embodiment, compared with the mounting of the rotating toothbrush head into the toothbrush handle, when the sonic toothbrush head is mounted to the toothbrush handle, an operating frequency of a motor inside the toothbrush handle is higher.

In at least one possible embodiment, when the operation mode of the electric toothbrush is the sonic mode, the vibration frequency of the sonic toothbrush head is from 150 to 450 Hz.

In at least one possible embodiment, when the operation mode of the electric toothbrush is the rotating mode, the vibration frequency of the rotating toothbrush head is from 40 to 150 Hz.

In at least one possible embodiment, identification methods of the identification object and the identification point include a physical contact point identification, a circuit connection identification, a radio frequency tag identification, an optical identification, or a near field communication identification.

In at least one possible embodiment, the control method of the electric toothbrush further includes: determining whether the toothbrush head is mounted on the toothbrush handle based on the interaction between the identification point and the identification object after being powered on, and prompting mounting the toothbrush head when the identification object is not identified.

In at least one possible embodiment, the control method of the electric toothbrush further includes: outputting an identification result by the electric toothbrush when identifying that the sonic toothbrush head or the rotating toothbrush head is mounted on the toothbrush handle.

The embodiments of the present disclosure further propose an electric toothbrush, using the control method of the electric toothbrush described in any one of the above technical solutions, and the electric toothbrush includes a toothbrush handle, a sonic toothbrush head, and a rotating toothbrush head.

A drive shaft is arranged on one end of the toothbrush handle; the drive shaft includes a first support section and a second support section; the second support section surrounds a base end part of the first support section; the first support section can move relative to the second support section; a motor is arranged inside the toothbrush handle; and an output end of the motor is connected to the first support section to drive the first support section to move relative to the second support section.

In at least one possible embodiment, under a state that the sonic toothbrush head is mounted to the toothbrush handle, the first support section and the sonic toothbrush head are cooperatively connected, and a gap exists between the second support section and the sonic toothbrush head, so that the motor can drive the sonic toothbrush head to vibrate via the first support section.

In at least one possible embodiment the rotating toothbrush head includes a brush rod housing, a connecting rod, and a round brush head, wherein the connecting rod is arranged inside the brush rod housing, the round brush head can be rotationally connected to the brush rod housing relative to the brush rod housing, and a head end of the connecting rod is connected to the round brush head.

In a state that the rotating toothbrush head is mounted to the toothbrush handle, a tail end of the connecting rod is connected to the first support section; the connecting rod and the round brush head form a crank-rocker mechanism; and the brush rod housing is connected to the second support section.

The electric toothbrush of the present disclosure includes the following beneficial effects. The electric toothbrush can automatically switch to different operation modes according to different types of the brush heads mounted, which eliminates the need to manually adjust the operation mode suitable for the type of brush head to be mounted, thereby making the electric toothbrush easy to operate.

### BRIEF DESCRIPTION OF DRAWINGS

In order to more clearly illustrate the technical solutions in the embodiments, the following will briefly introduce drawings of the embodiments. It is obvious that the drawings in the following description are only some embodiments of the present disclosure. For a person of ordinary skill in the art, other drawings can be obtained based on these drawings without inventive efforts.

FIG. 1 is a side view of a toothbrush handle of the electric toothbrush of an embodiment of the present disclosure;

FIG. 2 is a partial enlarged view at A of the electric toothbrush of FIG. 1;

FIG. 3 is a partial three-dimensional view of a toothbrush handle of an embodiment of the electric toothbrush of the present disclosure;

FIG. 4 is a partial three-dimensional view of a toothbrush handle of the electric toothbrush of another embodiment of the present disclosure;

FIG. 5 is a partial three-dimensional view of a toothbrush handle of the electric toothbrush of another embodiment of the present disclosure;

FIG. 6 is a three-dimensional view of a sleeve of the electric toothbrush of an embodiment the present disclosure;

FIG. 7 is a longitudinal sectional view of a first use state of the electric toothbrush of the present disclosure;

FIG. 8 is a partial enlarged view at B of the electric toothbrush of FIG. 7;

FIG. 9 is a longitudinal sectional view of a second use state of the electric toothbrush of the present disclosure;

FIG. 10 is another longitudinal sectional view of a second use state of the electric toothbrush of the present disclosure;

FIG. 11 is a flow diagram of a control method of the electric toothbrush of the present disclosure;

FIG. 12 is a coordinate diagram of a relationship between a cleaning effect and a time when a sonic toothbrush head of the electric toothbrush of the present disclosure is in use; and

FIG. 13 is a coordinate diagram of a relationship between a cleaning effect and a time when a rotating toothbrush head of the electric toothbrush of the present disclosure is in use.

### REFERENCE NUMBERS

1—bottom cover assembly; 2—battery; 3—PCB; 4—light-shielding member; 5—motor; 6—handle housing; 7—sonic toothbrush head; 8—rotating toothbrush head; 81—connecting rod; 82—round brush head; 83—brush rod housing; 84—second male buckle; 85—positioning hole; 9—first support section; 91—flattened plane; 92—female buckle; 93—chamfer; 94—convex curved surface; 10—second support section; 101—inward recessing surface; 102—abutting part; 104—third male buckle; 11—sleeve; 111—assembly hole; 112—convex edge; 113—protrusion; 114—window hole; 115—sloped platform; 116—first male buckle; 12—gap; 13—through hole.

### DETAILED DESCRIPTION OF EMBODIMENTS

The exemplary embodiments of the present disclosure are described below with reference to the drawings. It should be understood that these specific illustrations are intended only to teach those skilled in the art how to implement the present disclosure, and are not intended to exhaust all possible methods of the present disclosure, nor to limit the scope of the present disclosure.

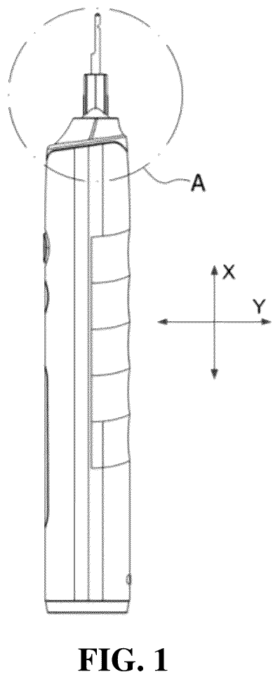

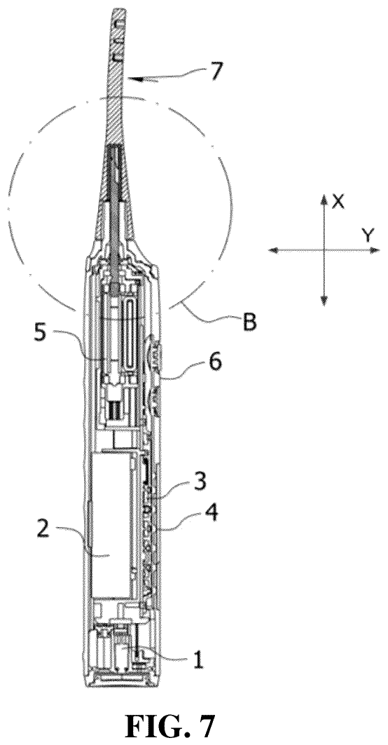

Hereinafter, a length direction of the electric toothbrush is referred to as the longitudinal or axial direction, which corresponds to the X-direction in the figures, and an extension direction of bristles of the toothbrush head is referred to as the frontward/rearward direction, which corresponds to the Y-direction in the figures. As can be seen from FIG. 1 and FIG. 7, some operation buttons can be arranged at the front side of the toothbrush handle, wherein the front side can be a side where the brush bristle contact with the teeth; and a direction of the electric toothbrush that is perpendicular to the above length direction and frontward/rearward direction is referred to as the transverse direction or leftward/rightward direction, which is consistent with the Z direction in the figures.

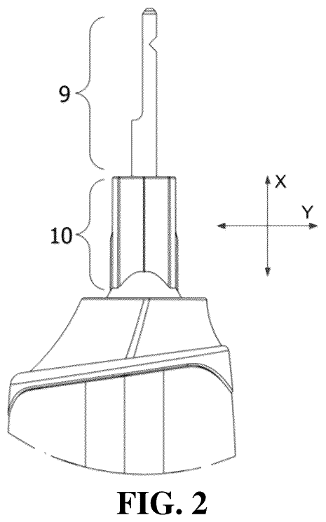

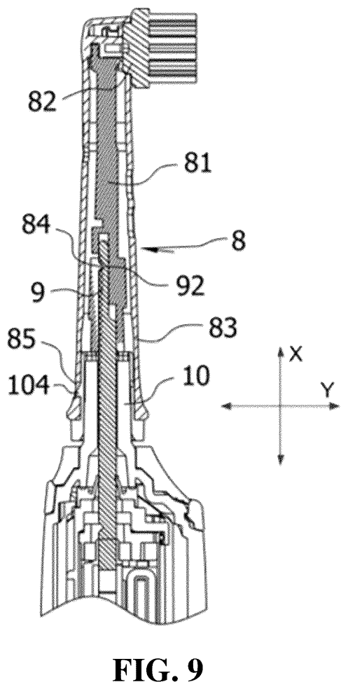

Referring to FIGS. 2, 3, 4, 7, and 9, the embodiments of the present disclosure provide an electric toothbrush, which in particular can be a dual-function electric toothbrush for sonic and rotational operation. The electric toothbrush includes a toothbrush handle and a toothbrush head. FIG. 1 shows a complete toothbrush handle, and a drive shaft is arranged on one end of the toothbrush handle. As shown in FIG. 2, the drive shaft includes a first support section 9, and the other section is a second support section 10. The toothbrush head is replaceable and selectable. The toothbrush head includes a sonic toothbrush head 7 and a rotating toothbrush head 8, and the sonic toothbrush head 7 or the rotating toothbrush head 8 can be selected to be mounted on the toothbrush handle. The sonic toothbrush head 7 is mounted to the first support section 9 accordingly, and the rotating toothbrush head 8 is mounted to the second support section 10 accordingly. As shown in FIG. 9, the rotating toothbrush head 8 includes at least a brush rod housing 83 and a round brush head 82, wherein a connecting rod 81 is arranged inside the brush rod housing 83, the round brush head 82 can be rotationally connected to the brush rod housing 83 relative to the brush rod housing 83, and a head end (upper end in FIG. 9) of the connecting rod 81 is connected to the round brush head 82. In a state that the rotating toothbrush head 8 is mounted to the toothbrush handle, a tail end (lower end in FIG. 9) of the connecting rod 81 is connected to the first support section 9, the connecting rod 81 and the round brush head 82 form a crank-rocker mechanism, and the brush rod housing 83 is connected to the second support section 10.

The first support section 9 can be assembled with the connecting rod 81 inside the rotating toothbrush head 8, and the second support section 10 is assembled with the brush rod housing of the rotating toothbrush head 8. The crank-rocker mechanism will convert the transverse swing of the first support section 9 into a rotating movement of the round brush head (bristles) of the rotating toothbrush head around its central axis (the axis extending along the frontward/rearward direction Y of the electric toothbrush). At the same time, the relative position of the second support section 10 to the brush rod housing of the rotating toothbrush head 8 remains unchanged, which ensures the normal operation of the crank-rocker mechanism and makes the brush rod housing 83 of the rotating toothbrush head 8 remain stable. It can be understood that the bristles of the rotating toothbrush head driven by the crank-rocker mechanism can rotate reciprocally within a certain angle range (e.g., from the range of 0 to 5 degrees to the range of 0 to 60 degrees), rather than continuously rotating in one direction.

The second support section 10 surrounds the base end part (lower end part of FIG. 2) of the first support section 9, and the front end part of the first support section 9 is exposed from the second support section 10. The first support section 9 can move relative to the second support section 10.

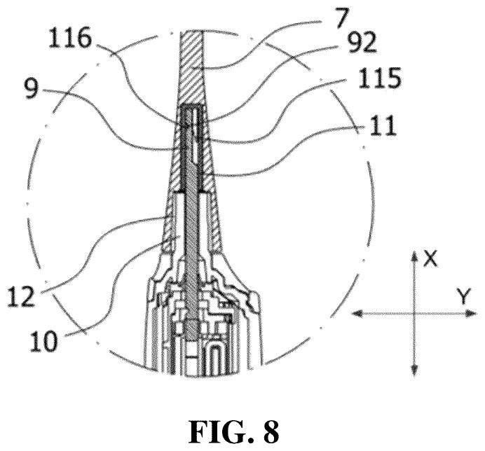

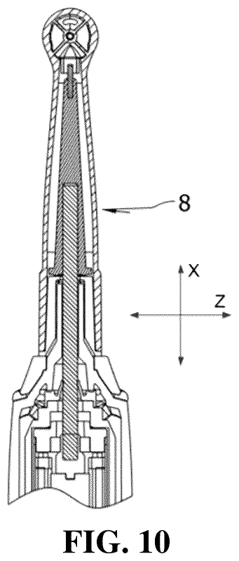

As shown in FIG. 7 and FIG. 8, when the sonic toothbrush head 7 is mounted to the first support section 9, the first support section 9 is provided with a transverse vibrational degree of freedom (which can correspond to the Z-direction in the figures) relative to the second support section 10. The length direction (which can correspond to X-direction in the figures) along the electric toothbrush is the longitudinal direction. The transverse direction in the transverse vibrational degree of freedom herein refers to a direction that is perpendicular to the longitudinal direction (which can correspond to X-direction in the figures) and the frontward/rearward direction (which can correspond to Y-direction in the figures), and the transverse direction can also be referred to as a leftward/rightward direction. As shown in FIG. 9 and FIG. 10, the perspective of FIG. 10 is rotated by 90° compared to the perspective of FIG. 9. When the second support section 10 is assembled with the rotating toothbrush head 8, the second support section 10 is assembled with the brush rod housing 83 for position limitation, and the first support section 9 is assembled with the connecting rod 81 for position limitation. The first support section 9 has a transverse vibration (or swing) degree of freedom relative to the second support section 10, that is, whether the sonic toothbrush head 7 operates or the rotating toothbrush head 8 operates, the first support section 9 moves relative to the second support section 10. The respective structures of the first support section 9 and the second support section 10 are simple and reliable, and can be easily assembled with the sonic toothbrush head 7 and the rotating toothbrush head 8.

In an embodiment, the first support section 9 is in interference fit with or snapped fit with the sonic toothbrush head 7, and the second support section 10 is in interference fit with or snapped fit with the rotating toothbrush head 8.

Whether choosing the interference fit or a snap fit, the main point is to ensure that the sonic toothbrush head 7, the rotating toothbrush head 8, and the drive shaft are able to be quickly disassembled, replaced, and fixed in a limited position.

As shown in FIG. 2, in an embodiment, the first support section 9 as a whole (or the front end part of the first support section 9) is closer to the top end (the end close to the toothbrush head) of the toothbrush handle than the second support section 10. In other words, the longitudinal distance from the first support section 9 to the centroid of the toothbrush handle is greater than the longitudinal distance from the second support section 10 to the centroid of the toothbrush handle, i.e., the second support section 10 is located at the tail part of the drive shaft, and the first support section 9 is located at the top end of the top end. That is, the second support section 10 is located at a lower position in the longitudinal direction (which can correspond to the X-direction in the figures) relative to the first support section 9. In addition, the transverse dimension and the front direction dimension of the second support section 10 are larger than the transverse dimension and the front direction dimension of the first support section 9. It ensures that the two different types of toothbrush heads have their own dedicated mounting positions, thus ensuring the accurate mounting.

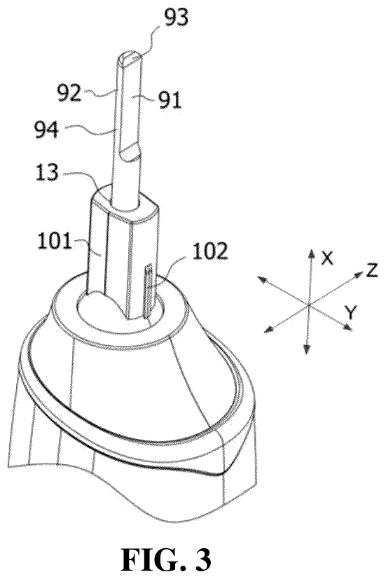

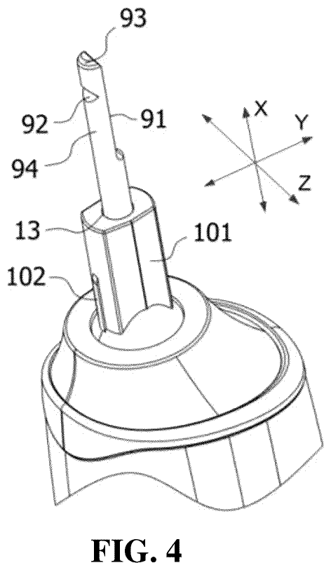

As shown in FIG. 3 and FIG. 4, the second support section 10 is provided with a through hole 13 for the first support section 9 to movably pass through, and an inner diameter of the through hole 13 is greater than an outer diameter of the first support section 9. Since the first support section 9 can move relative to the second support section 10, the first support section 9 can move in the space provided by the through hole 13, and the vibration (or swing) of the first support section 9 is not limited; and spaces are also provided in the radial direction to ensure that the first support section 9 can vibrate smoothly.

In an embodiment, when the first support section 9 is assembled with the sonic toothbrush head 7, at least a gap exists between the second support section 10 and the sonic toothbrush head 7 in the transverse direction. As shown in FIG. 8, a gap 12 also exists between the second support section 10 and the sonic toothbrush head 7 in the frontward/rearward direction. The sonic toothbrush head 7 can be spaced apart to cover the second support section 10 or not cover the second support section 10. When the electric toothbrush is in operation, the bristles of the sonic toothbrush head 7 can reciprocate along the length direction X of the electric toothbrush. The brush rod of the sonic toothbrush head 7 can be an integral structure. During the vibration of the sonic toothbrush head 7, the two ends of brush rod often vibrate in a large amplitude. These gaps can prevent the second support section 10 from interfering with the vibrating sonic toothbrush head 7, which ensures smoothness and stability of the vibration.

As shown in FIG. 3 and FIG. 4, in an embodiment, the first support section 9 includes a flattened section. The outer wall of the flattened section includes a convex curved surface 94 and a flattened plane 91; the flattened plane 91 is parallel to the length direction (which can correspond to the X-direction in the figures) of the first support section 9. The cross-sectional profile of the flattened section can be a D-shaped, where the D-shape includes an arcuate shape such as a semicircle. A female buckle 92 snapped to the sonic toothbrush head 7 is recessed on the convex curved surface 94.

The first support section 9 is not in a regular cylindrical shape, and the special cross-sectional shape of the first support section 9 is capable of restricting the tendency of the drive shaft to rotate or loosen about its own axial line after being assembled with the toothbrush head.

As shown in FIG. 3 and FIG. 4, in an embodiment, the top end of the first support section 9, i.e., the top end of the drive shaft, is provided with a chamfer 93, and the chamfer 93 can reduce the alignment accuracy requirement of which the drive shaft is assembled with different toothbrush heads.

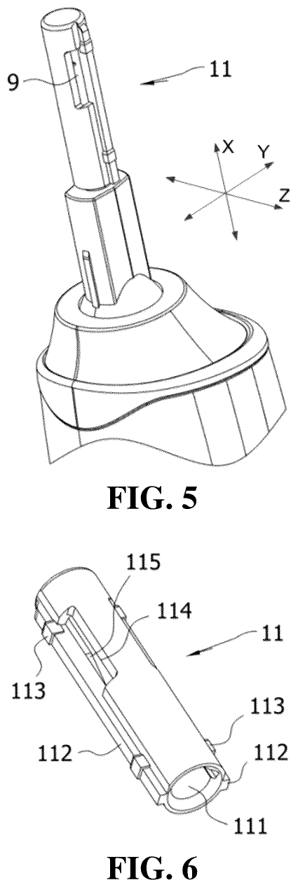

As shown in FIG. 5, FIG. 6, FIG. 7, and FIG. 8, in an embodiment, a sleeve 11 is arranged between the first support section 9 and the sonic toothbrush head 7; the outer wall of the sleeve 11 is provided with convex edges 112; the length direction of the convex edges 112 (which can correspond to the X-direction in the figures) is parallel to the axial direction of the sleeve 11 (which can correspond to the X-direction in the figures); each convex edge 112 is provided with a protrusion 113; and the top end of the protrusion 113 is in an interference fit with the sonic toothbrush head 7.

The sleeve 11 facilitates changing the shape of the outer contour of the first support section 9 in the drive shaft, thus facilitating the assembly with the specific sonic toothbrush head 7.

As shown in FIG. 6, a pair of convex edges 112 are arranged on two sides of the sleeve 11 in a mirror symmetrical manner, and two protrusions 113 are arranged on each convex edge 112, so that a total of four protrusions 113 can participate in the interference fit assembly. The cross-sectional profiles of the convex edge 112 and the protrusion 113 can be rectangles.

The inner wall of the sonic toothbrush head 7 is provided with two clamping grooves, and a distance between two clamping grooves is designed to be slightly smaller than a width between the two convex edges 112 of the sleeve 11. When the sonic toothbrush head 7 is mounted, the clamping groove needs to be moderately expanded outward to accommodate the width of the drive shaft after being sleeved with the sleeve. This design ensures a tight contact between the sonic toothbrush head 7 and the drive shaft, so that the sonic toothbrush head 7 is more stable during use, thereby reducing the risk of loosening and falling.

As shown in FIG. 6, in an embodiment, one end of the sleeve 11 is provided with an assembly hole 111 for entrance of the first support section 9. As shown in FIG. 8, the inner wall of the assembly hole 111 is provided with a first male buckle 116, and the first male buckle 116 can be snap-fit assembled with the female buckle 92. As shown in FIG. 6 and FIG. 8, the inner wall of the assembly hole 111 is further provided with a sloped platform 115, and the sloped platform 115 can contact with the flattened plane 91. The sloped surface of the sloped platform 115 faces the opening direction of the assembly hole 111, the inclined surface of the sloped platform 115 guides the drive shaft to move slightly in the frontward/rearward direction, and finally, the top of the sloped platform 115 abuts against the flattened plane 91 of the drive shaft, so that the first male buckle 116 and the female buckle 92 are firmly assembled.

As shown in FIG. 6, in an embodiment, the sleeve 11 has a window hole 114 penetrating inside and outside. The window hole 114 facilitates disruption of the blind hole feature of the assembly hole 111, so that the first support section 9 smoothly enters the assembly hole 111.

As shown in FIG. 3 and FIG. 4, in an embodiment, the outer wall of the second support section 10 includes a plurality of outwardly protruding abutting parts 102; the abutting parts 102 are arranged in mirror symmetry or in an annular array around a centerline of the second support section 10; and the abutting parts 102 are assembled in interference fit with the rotating toothbrush head 8. The abutting part 102 is configured to limit the swing of the rotating toothbrush head 8 and to enhance the stability during use.

The length direction of the abutting part 102 (which can correspond to the X-direction in the figures) can be parallel to the length direction of the second support section 10 (which can correspond to the X-direction in the figures), and one end of the abutting part 102 toward the first support section 9 can be provided with a chamfer, wherein the chamfer facilitates the guidance of the assembly of the second support section 10 with the rotating toothbrush head 8. The outer wall of the second support section 10 is further provided with a radial inward recessing surface 101 at a position where the abutting part 102 is not arranged. Two inward recessing surfaces 101 and two abutting parts 102 can be provided, and a transverse distance between a pair of the inward recessing surfaces 101 is smaller than a transverse distance between a pair of the abutting parts 102. The inward recessing surface 101 does not contact with the rotating toothbrush head 8. In a non-limiting example, the direction of the line connecting a pair of abutting parts 102 is perpendicular to the flattened plane 91.

The second support section 10 can be an injection molded member, and the second support section 10 can be an injection molded member that is integrally molded with the toothbrush handle main body. This ensures that the brush rod housing 83 of the rotating toothbrush head 8 after being mounted is relatively fixed to the toothbrush handle main body.

As shown in FIG. 9, in an embodiment, a second male buckle 84 is arranged on the surface of the connecting rod 81 of the rotating toothbrush head 8, and the second male buckle 84 can be snap-fit assembled with the female buckle 92, so that the connecting rod 81 can move synchronously with the first support section 9.

In addition, as shown in FIG. 9, a third male buckle 104 can be arranged on a side edge of the second support section 10, and at the same time, the brush rod housing 83 is provided with a positioning hole 85, wherein the third male buckle 104 can be snap-fitted to assemble with the positioning hole 85. The third male buckle 104 and positioning hole 85 can provide a more stable limiting capability. Whether it is the snap-fit assembly between the first male buckle 116 and female buckle 92, the snap-fit assembly between the second male buckle 84 and female buckle 92, or the snap-fit assembly between the third male buckle 104 and positioning hole 85, all belong to the mechanical locking. The mechanical locking can prevent the toothbrush head from rotating or loosening during use. Especially, when mounting the sonic toothbrush head 7 or the rotating toothbrush head 8, the users will also perceive a noticeable snapping sensation, which serves to remind the user that the toothbrush head has been correctly mounted in place. The third male buckle 104 essentially serves as a functional supplement to the abutting part 102.

In an embodiment, the drive shaft is provided with an identification point, and the sonic toothbrush head 7 and the rotating toothbrush head 8 have identification objects with different identification features. The identification point (control system) can identify the identification objects having different identification features, so as to determine whether the toothbrush head mounted to the toothbrush handle is the sonic toothbrush head 7 or the rotating toothbrush head 8. The identification principle of the identification point includes, but is not limited to physical contact point identification, circuit connection identification, RFID (radio frequency identification, i.e., radio frequency tag identification), optical identification, and NFC (near field communication, i.e., near field communication identification).

The physical contact point identification is realized by arranging electrical contact points (e.g., metal contact points) on the drive shaft, and the sonic toothbrush head 7 and the rotating toothbrush head 8 can adopt different contact methods or electrical connection solutions. The connecting part of the handle drive shaft and the connection end of the brush head can be designed as different electrical contact points (such as metal contact point), and different brush heads have different contact methods or electrical connection solutions. For example, different electrical contact points can have different resistances, and the sonic toothbrush head 7 and the rotating toothbrush head 8 can have different resistance values at the electrical contact points that come into contact with the identification point. For another example, different electrical contact points can have different inductances; the interior of the toothbrush handle can have an inductance sensor; the inductance sensor can detect the inductance of the electrical contact point of the toothbrush head; and the sonic toothbrush head 7 and the rotating toothbrush head 8 can have different inductance responses.

The principle of radio frequency tag identification is non-contact data communication between the reader and the tag to achieve the purpose of identifying the target, i.e., the reader and the tag can be mounted on the drive shaft and the toothbrush head at the designated positions.

The near field communication identification is developed on the basis of non-contact radio frequency identification technology and combined with wireless interconnection technology, and the near field refers to radio waves near the electromagnetic field. The arrangement position of the identification point can be on the flattened plane 91, and the flattened plane 91 has a relatively sufficient plane for arrangement. Specifically, the identification point of a certain principle can be selected according to actual needs.

As shown in FIG. 7, the outer surface of the toothbrush handle is wrapped by the handle housing 6. In the direction toward the toothbrush head, the handle housing 6 is provided with the bottom cover assembly 1, the battery 2, and the motor 5 in sequence. The PCB 3 is arranged on the same side of the battery 2 and the motor 5; the PCB 3 is located inside the handle housing 6; a light-shielding member 4 is further covered on the PCB 3; and the light-shielding member 4 facilitates the formation of a hidden panel.

The motor 5 is connected to a power rod; the power rod passes through the second support section 10; and the part exposed from one end of the second support section 10 is the first support section 9 of the drive shaft. The part of the power rod that connects to the first support section 9 and is located within the second support section 10 can be referred to as the base end part of the first support section 9. The motor 5 has at least the function of driving the power rod to vibrate.

Optionally, the PCB board 3 can be provided with a level switching button, and the level switching button can be exposed from the surface of the toothbrush handle. When the rotating toothbrush head 8 is mounted on the toothbrush handle and the level switching button is triggered, the control system can adjust operation parameters of the motor 5 (e.g., adjusting the movement amplitude of the power rod of the motor), so that the operation mode of the electric toothbrush is switched to the sweeping vibration mode. In the sweeping vibration mode, the rotating toothbrush head 8 can alternately perform rotational and vibrating actions. The button-based switching and identification point-based switching methods can be collectively referred to as strain-based switching.

In a non-limiting example, compared with the mounting of the rotating toothbrush head 8 into the toothbrush handle, when the sonic toothbrush head 7 is mounted to the toothbrush handle, an operating frequency of the motor 5 inside the toothbrush handle is higher. The vibration frequency of the motor or the component driven by the motor can be in the range of 40-450 Hz; the vibration frequency of the sonic toothbrush head can be in the range of 150-450 Hz; and the vibration frequency of the rotating toothbrush head can be in the range of 40-150 Hz. The working mode of the electric toothbrush can be selected between the sonic mode and the rotating mode by adjusting the frequency.

When the electric toothbrush is in sonic mode, the motor transmits high-frequency vibrations of 150 to 450 Hz to the bristles of the sonic toothbrush head 7, so that the bristles can vibrate in the leftward/rightward direction. During the vibration of the sonic toothbrush head 7, the bristles can perform high-frequency vibrations and contact with the surface of the teeth and gaps between the teeth, so that the dental plaque and food debris can be effectively removed by a smaller movement amplitude and a higher frequency vibration. The sonic mode is suitable for daily cleaning and sensitive teeth care.

When the electric toothbrush is in the rotating mode, the motor will drive the rotating toothbrush head 8 to rotate 360 degrees on the surface of the teeth and rub against the surface of the teeth. During the rotation of the rotating toothbrush head 8, the bristles can make omnidirectional contact with the tooth surface, making them particularly suitable for cleaning surface stains and areas along the gumline, and the cleaning intensity is relatively high. The rotating mode is suitable for cleaning difficult-to-reach areas and performing deep cleaning.

When testing the cleaning force, pigment can be applied to the tooth surface to simulate dental plaque. The cleaning effect of the electric toothbrush can be measured by the proportion of the area of pigment removed by the toothbrush head at different vibration frequencies of the motor within a specific period of time.

Table 1 shows the proportion of the area of pigment removed by the toothbrush head at different vibration frequencies of the motor within a specific period of time. The tests were conducted with the sonic toothbrush head 7 mounted on the toothbrush handle operating in the sonic mode, and with the rotating toothbrush head 8 mounted on the toothbrush handle operating in the rotating mode.

TABLE 1

| | | Cleaning effect |
|---|---|---|
| Vibration | Cleaning effect | of rotating |
| frequency | of sonic | toothbrush |
| (Hz) | toothbrush head | head |
| 20 | 70% | 70% |
| 30 | 75% | 73% |
| 40 | 78% | 75% |
| 50 | 80% | 77% |
| 80 | 83% | 80% |
| 100 | 85% | 85.47% |
| 150 | 88% | 83% |
| 200 | 90% | 81% |
| 250 | 91% | 79% |
| 300 | 92% | 77% |
| 350 | 93% | 75% |
| 400 | 91.6% | 72% |
| 450 | 94% | 70% |
| 500 | 92% | 68% |
| 550 | 90% | 65% |

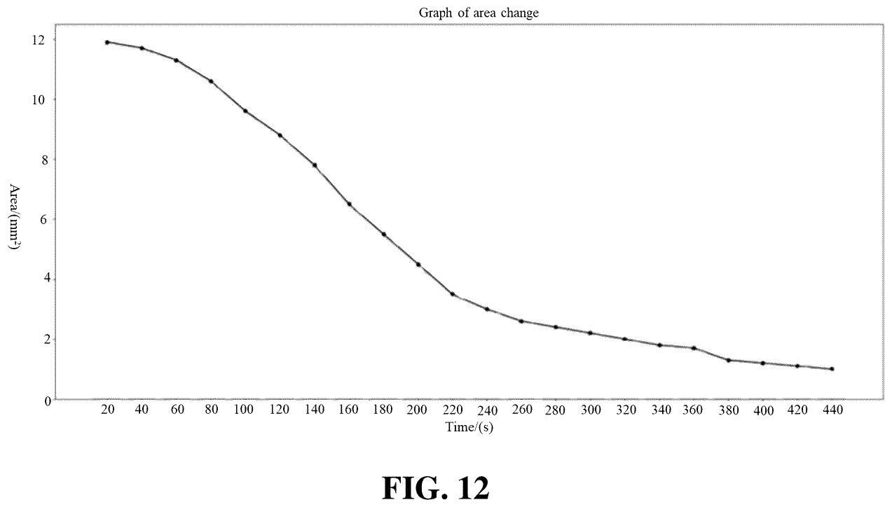

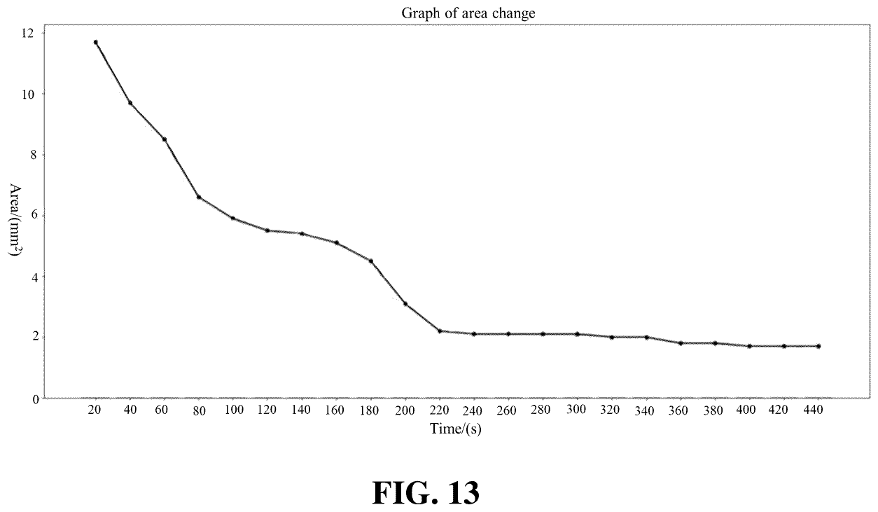

In FIG. 12 and FIG. 13, the horizontal coordinate represents time, and the vertical coordinate represents the area of pigment coated on the tooth surface for simulating the dental plaque. The curve in FIG. 12 represents the rea of pigment remaining on the tooth surface after brushing for different durations, using the sonic toothbrush head 7 with the motor operating at a frequency of 400 Hz. Specifically, the area of pigment is reduced from 12 square millimeters to 1 square millimeter when the teeth are cleaned for 440 seconds by using the sonic toothbrush head 7.

The curve in FIG. 13 represents the rea of pigment remaining on the tooth surface after brushing for different durations, using the rotating toothbrush head 8 with the motor operating at a frequency of 100 Hz. Specifically, the area of pigment is reduced from 12 square millimeters to 1.7 square millimeters when the teeth are cleaned for 440 seconds by using the rotating toothbrush head 8.

The operation mode of one embodiment of the electric toothbrush in the present disclosure is as follows, including steps S101~S105.

Step S101: mounting the sonic toothbrush head 7. The sonic toothbrush head 7 is mounted on the drive shaft of the toothbrush handle by the user. The sonic toothbrush head 7 is tightly fitted to the first support section 9 by the interference assembly. Step S102: identifying the brush head type. Since the drive shaft is provided with the identification point, the toothbrush handle can identify the type of the brush head mounted. Step S103: signal transmission. The drive shaft sends the first signal to the control system in the toothbrush handle when identifying that the sonic toothbrush head 7. Step S104: mode adjustment. The control system adjusts the operation mode of the electric toothbrush to adapt to the requirement of the sonic toothbrush head 7 after receiving the first signal. The control system sets appropriate parameters, such as speed, angle, and moment, so as to ensure the best cleaning effect. Step S105, starting the electric toothbrush. The user presses the start button of the electric toothbrush; the electric toothbrush starts to operate; and the control system drives the motor 5 to run in a set state according to the previously adjusted mode.

The operation mode of another embodiment of the electric toothbrush in the present disclosure is as follows, including steps S201~S205.

Step S201: mounting the rotating toothbrush head 8. The rotating toothbrush head 8 is mounted on the drive shaft of the toothbrush handle by the user. Different parts of the rotating toothbrush head 8 are closely fitted to the second support section 10 and the first support section 9 respectively. Step S202: identifying the brush head type. Since the drive shaft is provided with the identification point, the toothbrush handle can identify the type of the brush head mounted. Step S203: signal transmission. The drive shaft sends the second signal to the control system in the toothbrush handle when identifying the rotating toothbrush head 8. Step S204: mode adjustment. The control system adjusts the operation mode of the electric toothbrush to adapt to the requirement of the rotating toothbrush head 8 after receiving the second signal. The control system sets appropriate parameters, such as speed, angle, and moment, so as to ensure the best cleaning effect. Step S205, starting the electric toothbrush. The user presses the start button of the electric toothbrush; the electric toothbrush starts to operate; and the control system drives the motor to run in a set rotating mode according to the previously adjusted mode.

Optionally, the electric toothbrush can output the identification result when identifying that the sonic toothbrush head 7 or the rotating toothbrush head 8 is mounted to the toothbrush handle. For example, the type of toothbrush head mounted can be prompted to the user by voice, display screen, and lights.

Understandably, after the electric toothbrush is powered on, based on the interaction between the identification point and the identification object, it is determined whether a toothbrush head is mounted on the toothbrush handle. If the identification point fails to recognize any identification feature, it can be determined that neither the sound wave brush head nor the rotating brush head is mounted on the toothbrush handle. In this case, the toothbrush handle can prompt the user to mount the toothbrush head by light, sound, display screen, etc.

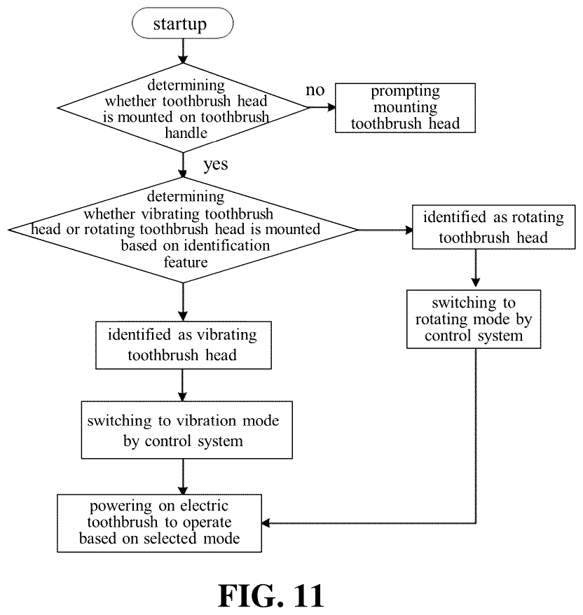

The electric toothbrush of the present disclosure can automatically switch to different operation modes according to different types of the brush heads mounted to the toothbrush handle, of which the control method can be referred in FIG. 11. Therefore, no manual adjustment of the operation mode suitable for the mounted brush head type is required, thereby making the electric toothbrush easy to operate.

The above-described embodiments are merely intended to illustrate the technical concept and features of the present disclosure, so as to enable those skilled in the art to understand and implement the present disclosure, and shall not be construed as limiting the scope of protection thereof. Any equivalent changes or modifications made in accordance with the spirit and substance of the present disclosure shall be covered by the scope of protection of the present disclosure.

1. A control method of an electric toothbrush, wherein the electric toothbrush comprises a sonic mode and a rotating mode, and the electric toothbrush is able to switch between the sonic mode and the rotating mode.

2. The control method of the electric toothbrush according to claim 1, wherein the sonic mode and the rotating mode are switched by a strain-based manner.

3. The control method of the electric toothbrush according to claim 1, wherein the sonic mode and the rotating mode are switched by a level switching button and/or an identification point.

4. The control method of the electric toothbrush according to claim 1, wherein
the electric toothbrush comprises a toothbrush handle, a sonic toothbrush head, and a rotating toothbrush head; the toothbrush handle is provided with an identification point; and the sonic toothbrush head and the rotating toothbrush head are provided with identification objects having different identification features;
under a condition that the sonic toothbrush head or the rotating toothbrush head is mounted to the toothbrush handle,
when the sonic toothbrush head is mounted on the toothbrush handle, the identification point transmits a first signal to a control system in the toothbrush handle, and the control system adjusts an operation mode of the electric toothbrush to a sonic mode after receiving the first signal; and
when the rotating toothbrush head is mounted on the toothbrush handle, the identification point transmits a second signal to a control system in the toothbrush handle, and the control system adjusts the operation mode of the electric toothbrush to a rotating mode after receiving the second signal.

5. The control method of the electric toothbrush according to claim 4, wherein
bristles of the sonic toothbrush head move reciprocally in a length direction of the electric toothbrush when the operation mode of the electric toothbrush is the sonic mode, and
the bristles of the rotating toothbrush head rotate reciprocally around an axis of the electric toothbrush extending in a frontward/rearward direction when the operation mode of the electric toothbrush is the rotating mode.

6. The control method of the electric toothbrush according to claim 4, wherein, compared with a mounting of the rotating toothbrush head into the toothbrush handle, when the sonic toothbrush head is mounted to the toothbrush handle, an operating frequency of a motor inside the toothbrush handle is higher.

7. The control method of the electric toothbrush according to claim 4, wherein, when the operation mode of the electric toothbrush is the sonic mode, a vibration frequency of the sonic toothbrush head is from 150 to 450 Hz.

8. The control method of the electric toothbrush according to claim 4, wherein, when the operation mode of the electric toothbrush is the rotating mode, the vibration frequency of the rotating toothbrush head is from 40 to 150 Hz.

9. The control method of the electric toothbrush according to claim 4, wherein identification methods of the identification object and the identification point comprise a physical contact point identification, a circuit connection identification, a radio frequency tag identification, an optical identification, or a near field communication identification.

10. The control method of the electric toothbrush according to claim 4, wherein the control method of the electric toothbrush further comprises: determining whether the toothbrush head, after being powered on, is mounted on the toothbrush handle based on an interaction between the identification point and the identification object, and prompting mounting the toothbrush head when the identification object is not identified.

11. The control method of the electric toothbrush according to claim 4, wherein the control method of the electric toothbrush further comprises: outputting an identification result by the electric toothbrush when identifying that the sonic toothbrush head or the rotating toothbrush head is mounted on the toothbrush handle.

12. An electric toothbrush, comprising the control method of the electric toothbrush according to claim 1, wherein the electric toothbrush comprises the toothbrush handle, the sonic toothbrush head and the rotating toothbrush head; and
a drive shaft is arranged on one end of the toothbrush handle; the drive shaft comprises a first support section and a second support section; the second support section surrounds a base end part of the first support section; the first support section is able to move relative to the second support section; a motor is arranged inside the toothbrush handle; and an output end of the motor is connected to the first support section to drive the first support section to move relative to the second support section.

13. The electric toothbrush according to claim 12, wherein in a state that the sonic toothbrush head is mounted to the toothbrush handle, the first support section and the sonic toothbrush head are cooperatively connected, and a gap exists between the second support section and the sonic toothbrush head, so that the motor is able to drive the sonic toothbrush head to vibrate via the first support section.

14. The electric toothbrush according to claim 12, wherein the rotating toothbrush head comprises a brush rod housing, a connecting rod, and a round brush head; the connecting rod is arranged inside the brush rod housing; the round brush head is able to be rotationally connected to the brush rod housing relative to the brush rod housing; and a head end of the connecting rod is connected to the round brush head; and
in a state that the rotating toothbrush head is mounted to the toothbrush handle, a tail end of the connecting rod is connected to the first support section; the connecting rod and the round brush head form a crank-rocker mechanism; and the brush rod housing is connected to the second support section.

15. The electric toothbrush, comprising the control method of the electric toothbrush according to claim 2, wherein the electric toothbrush comprises the toothbrush handle, the sonic toothbrush head, and the rotating toothbrush head; and
a drive shaft is arranged on one end of the toothbrush handle; the drive shaft comprises a first support section and a second support section; the second support section surrounds a base end part of the first support section; the first support section is able to move relative to the second support section; a motor is arranged inside the toothbrush handle; and an output end of the motor is connected to the first support section to drive the first support section to move relative to the second support section.

16. The electric toothbrush according to claim 15, wherein in a state that the sonic toothbrush head is mounted to the toothbrush handle, the first support section and the sonic toothbrush head are cooperatively connected, and a gap exists between the second support section and the sonic toothbrush head, so that the motor is able to drive the sonic toothbrush head to vibrate via the first support section.

17. The electric toothbrush, comprising the control method of the electric toothbrush according to claim 3, wherein the electric toothbrush comprises the toothbrush handle, the sonic toothbrush head, and the rotating toothbrush head; and
a drive shaft is arranged on one end of the toothbrush handle; the drive shaft comprises a first support section and a second support section; the second support section surrounds a base end part of the first support section; the first support section is able to move relative to the second support section; a motor is arranged inside the toothbrush handle; and an output end of the motor is connected to the first support section to drive the first support section to move relative to the second support section.

18. The electric toothbrush according to claim 17, wherein in a state that the sonic toothbrush head is mounted to the toothbrush handle, the first support section and the sonic toothbrush head are cooperatively connected, and a gap exists between the second support section and the sonic toothbrush head, so that the motor is able to drive the sonic toothbrush head to vibrate via the first support section.

19. The electric toothbrush, comprising the control method of the electric toothbrush according to claim 4, wherein the electric toothbrush comprises the toothbrush handle, the sonic toothbrush head, and the rotating toothbrush head; and
a drive shaft is arranged on one end of the toothbrush handle; the drive shaft comprises a first support section and a second support section; the second support section surrounds a base end part of the first support section; the first support section is able to move relative to the second support section; a motor is arranged inside the toothbrush handle; and an output end of the motor is connected to the first support section to drive the first support section to move relative to the second support section.

20. The electric toothbrush according to claim 19, wherein in a state that the sonic toothbrush head is mounted to the toothbrush handle, the first support section and the sonic toothbrush head are cooperatively connected, and a gap exists between the second support section and the sonic toothbrush head, so that the motor is able to drive the sonic toothbrush head to vibrate via the first support section.
